(19) United States
(12) Patent Application Publication
(10) Pub. No.: US 2017/0326389 A1
(43) Pub. Date: Nov. 16, 2017

(54) Fall Arrest System

(71) Applicant: Eastman Outdoors, LLC, Flushing, MI (US)

(72) Inventors: David Vergara, White Lake, MI (US); Robert James Twomley, Linden, MI (US); John Harrington, Clarkston, MI (US)

(73) Assignee: Eastman Outdoors, LLC, Flushing, MI (US)

(21) Appl. No.: 15/591,710

(22) Filed: May 10, 2017

Related U.S. Application Data
(60) Provisional application No. 62/334,921, filed on May 11, 2016.

(51) Int. Cl. A62B 35/00

(52) U.S. Cl. CPC A62B 35/0006; A62B 35/0025

(57) ABSTRACT

A fall arrest system having elastic properties includes a torso harness system, a tether, and a securement system wherein, during use, the tether detachably couples the torso harness system to the securement system. As such, the fall arrest system is configured to arrest the fall of the user.

### CROSS-REFERENCE TO RELATED APPLICATIONS

This application claims the benefit of U.S. Provisional Patent Application No. 62/334,921 filed May 11, 2016, the entirety of which is hereby incorporated by reference.

### STATEMENT REGARDING FEDERALLY SPONSORED RESEARCH OR DEVELOPMENT

Not applicable.

### TECHNICAL FIELD

The instant disclosure relates to a fall arrest system, and in particular to a fall arrest system having elastic properties.

### BACKGROUND

Fall arrest harnesses are often used by those performing various tasks at elevated heights. As one example, hunters that are hunting from elevated heights, such as in trees or an elevated tree stand often employ fall arrest harnesses to protect against falls from such heights. However, conventional fall arrest harnesses are somewhat restrictive in nature, impeding the user's ability to move or to perform tasks, particularly because of a structure that is generally rigid and unyielding.

Accordingly, there exists a need for a fall arrest system that provides the user some degree of flexibility while elevated. For example, with respect to hunters, because hunting often is performed in colder weather and the hunters are typically sitting still while waiting for prey, the hunter will have donned several layers of clothing which limits flexibility of movement. The hunter's flexibility is further limited by conventional fall arrest systems that are constructed using heavy and unyielding material.

### SUMMARY

A non-limiting exemplary embodiment of a fall arrest system includes a torso harness system, a tether, and a securement system configured for being secured to an anchoring object or structure. The torso harness system includes an upper back portion, a lower back portion coupled to the upper back portion, left and right shoulder straps, a chest strap extending between the left and right shoulder straps, and left and right leg straps. Each shoulder strap is coupled to and extends between the upper back portion and the lower back portion. Each leg strap is defined at least in part by opposing first and second ends that are coupled to the lower back portion. The tether is defined at least in part by opposing first and second ends, wherein the first end is coupled to the torso harness system. At least a portion of at least one of the left shoulder strap, the right shoulder strap, the tether, the coupling between the upper and lower back portions, the left leg strap, and the right leg strap is elastic. In use, the second end of the tether and the securement system are detachably coupled to each other.

Another non-limiting exemplary embodiment of a fall arrest system includes a torso harness system, a tether, and a securement system configured for being secured to an anchoring object or structure. The torso harness system includes a back portion extending between opposing first and second ends, a waist portion coupled to the first end of the back portion, left and right shoulder straps, a chest strap extending between the left and right shoulder straps, and left and right leg straps. Each shoulder strap is coupled to and extends between the second end of the back portion and the waist portion. Each leg strap is defined at least in part by opposing first and second ends that are coupled to the waist portion. The tether is defined at least in part by opposing first and second ends, wherein the first end is coupled to the torso harness system. At least a portion of at least one of the back portion, the left shoulder strap, the right shoulder strap, the tether, the left leg strap, and the right leg strap is elastic. In use, the second end of the tether and the securement system are detachably coupled to each other.

### BRIEF DESCRIPTION OF THE DRAWINGS

FIGS. 1A and 1B, in combination, illustrate a non-limiting exemplary embodiment of a fall arrest system;

FIG. 1A illustrates a non-limiting exemplary embodiment of a torso harness system of the fall arrest system;

FIG. 1B illustrates a non-limiting exemplary embodiment of a securement system of the fall arrest system;

FIG. 2 illustrates a portion of the torso harness system of the fall arrest system disposed on a user's torso;

FIGS. 3A and 3B illustrate the left and right leg straps of the torso harness system disposed on the user of the fall arrest system;

FIG. 4 illustrates a non-limiting exemplary embodiment of an adjustment system for adjusting a length of the right shoulder strap;

FIG. 5 illustrates the torso harness system disposed on the user of the fall arrest system;

FIGS. 6A and 6B illustrate a non-limiting exemplary embodiment of securing the securement system to an object;

FIG. 7 illustrates the coupling of the tether of the torso harness system and the securement system to each other;

FIG. 8 illustrates a non-limiting exemplary embodiment of the fall arrest system during use;

FIG. 9 illustrates a non-limiting exemplary embodiment of another torso harness system;

FIG. 10 illustrates a non-limiting exemplary embodiment of yet another torso harness system;

FIG. 11 illustrates a non-limiting exemplary embodiment of another torso harness system;

FIG. 12 illustrates a non-limiting exemplary embodiment of a shoulder strap; and

FIG. 13 illustrates another non-limiting exemplary embodiment of a shoulder strap.

### DETAILED DESCRIPTION

One or more non-limiting embodiments are described herein with reference to the accompanying drawings, wherein like elements are designated by like numerals. It should be clearly understood that there is no intent, implied or otherwise, to limit the disclosure in any way, shape or form to the illustrated and described embodiments. While multiple exemplary embodiments are described, variations thereof will become apparent or obvious to a person of ordinary skill. Specific structural and functional details disclosed herein are not to be interpreted as limiting, but are to be construed as merely exemplary. Accordingly, any and all variants of the embodiments described herein are considered as being within the metes and bounds of the instant disclosure.

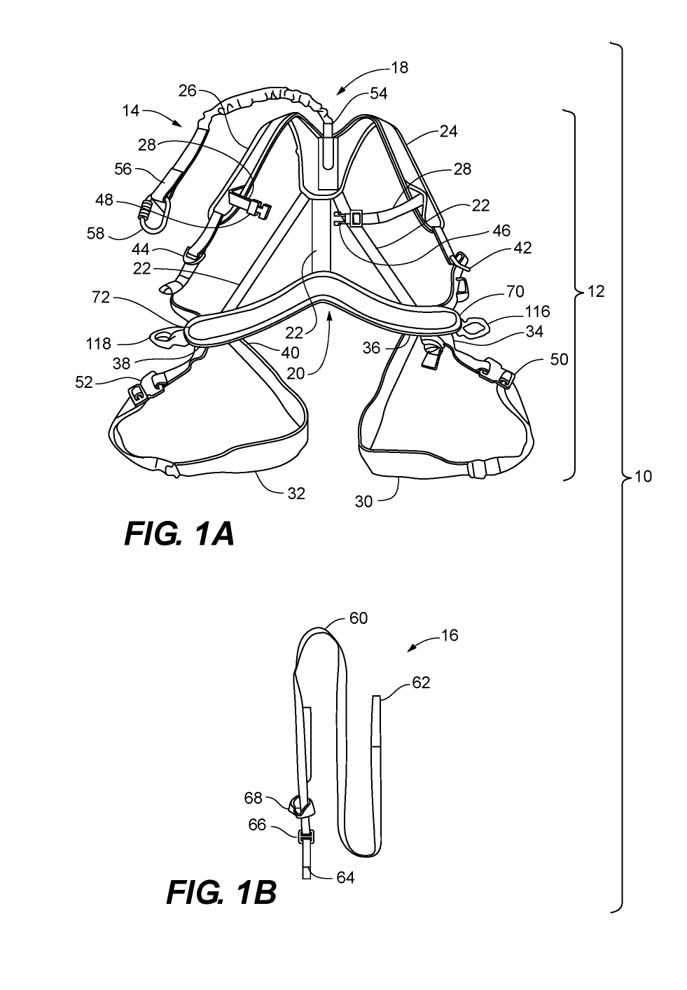

FIGS. 1A and 1B, in combination, illustrate a non-limiting exemplary embodiment of a fall arrest system 10 having a torso harness system 12, a tether 14, and a securement system 16.

In a non-limiting exemplary embodiment, the torso harness system 12 includes an upper back portion 18 and a lower back portion 20. In some embodiments, the upper and lower back portions 18 and 20 are coupled to each other with one or more straps 22 extending or spanning a back of a user of the fall arrest system 10. The torso harness system 12 additionally includes left and right shoulder straps 24 and 26, respectively. Each shoulder strap 24 and 26 is coupled to and extends between the upper and lower back portions 18 and 20 so as to form a loop for each shoulder. A chest strap 28 extending across the chest, i.e., the upper frontal torso, of the user couples the left and right shoulder straps 24 and 26 to each other. In certain embodiments, the chest strap 28 limits or restricts the separation between the left and right shoulder straps 24 and 26. The torso harness system 12 further includes left and right leg straps 30 and 32, respectively. In some embodiments, each leg strap 30 and 32 is configured as a loop coupled to the lower back portion 20. In certain embodiments, the left leg strap 30 includes opposing first and second ends 34 and 36 coupled to the lower back portion 20. Likewise, the right leg strap 32 includes opposing first and second ends 38 and 40 coupled to the lower back portion 20. As illustrated, each leg strap 30 and 32, when coupled to the lower back portion 18, forms a leg loop.

In a non-limiting exemplary embodiment, one or more of the left shoulder strap 24, the right shoulder strap 26, the chest strap 28, the left leg strap 30, and the right leg strap 32 are adjustable for a snug fitting of the torso harness system 12 to the user. In some embodiments, one or more of the straps 24, 26, 28, 30, and 32 is an adjustable cinching strap as is well known in the art. In certain embodiments, one or more of the straps 24, 26, 28, 30, and 32 includes a cinching device as is well known in the art. In some embodiments, the cinching device is configured for adjusting the length of the strap in a manner well known in the art. In some embodiments, one or more of the straps 24, 26, 28, 30, and 32 is a two-piece strap having a fastener, e.g., a buckle, for securing the two pieces of the strap to each other to form an integral or continuous strap. In certain embodiments, the fastener is configured for adjusting the length of the strap as is well known in the art. In some embodiments, one or more of the straps 24, 26, 28, 30, and 32 is a two-piece strap having cooperating fasteners for securing the two pieces of the strap to each other to form an integral or continuous strap. In certain embodiments, the cooperating fasteners are configured for adjusting the length of the strap as is well known in the art.

In a non-limiting exemplary embodiment of the torso harness system, for instance the torso harness system 12, the left and right shoulder straps 24 and 26, respectively, are illustrated having a cinching device 42 and 44 configured for adjusting the overall length of the corresponding shoulder strap; the chest strap 28 is illustrated as a two-piece strap having cooperating fasteners 46 and 48 configured for adjusting the length of the chest strap 28; and the left and right leg straps 30 and 32, respectively, are illustrated having a fastener, e.g., a buckle, 50 and 52 configured for adjusting the overall length of the corresponding leg strap. It should be clearly understood that the illustrated and/or described components for adjusting the lengths of the various strap are exemplary and should not be construed as limiting in any respect. To the contrary, any component equivalent to those illustrated and described with reference to a specific strap can be used.

In a non-limiting exemplary embodiment, the tether 14 includes opposing first and second ends 54 and 56. In some embodiments, the first end 54 is coupled to the torso harness system 12, and the second end 56 is configured for detachable coupling with the securement system 16. In some embodiments, the first end 54 is coupled to the upper back portion 12 of the fall arrest system 10. In certain embodiments, the second end 56 of the tether 14 and the securement system 16 are detachably coupleable to each other with a carabiner 58. In some embodiments, at least a portion of the tether 14 is configured as a shock absorber. In certain embodiments, at least a portion of the tether 14 is at least partially elastic.

In a non-limiting exemplary embodiment, the securement system 16 is configured for being secured to an object or an anchoring structure. In some embodiments, the securement system 16 includes a strap 60 extending between opposing first and second ends 62 and 64, and a securement device 66 for securing the strap to the anchoring structure. In certain embodiments, the strap 60 is a cinching strap as is well known in the art. In some embodiments, the securement device 66 is a cinching device or a buckle or cooperating fasteners as are well known in the art. In certain embodiments, the securement system 16 includes an anchoring device or an anchoring point 68 for detachably coupling with the second end 56 of the tether 14. In some embodiments, the anchoring device or point 68 is re-locatable along the length of the strap 60. In certain embodiments, the anchoring device or point 68 is fixedly coupled to the strap 60. In some embodiments, the anchoring device or point 68 is a loop configured for retaining a carabiner.

In a non-limiting exemplary embodiment, the torso harness system 12 includes a waist strap (not shown) coupled to the lower back portion 20 and extending across the lower front portion of the users torso. In some embodiments, the waist strap is adjustable for enabling a snug fit around the user's waist. In certain embodiments, the waist strap is integral or continuous with the lower back portion 20. In some embodiments, the waist strap is a separate component having opposing first and second ends respectively coupled to the first and second ends 70 and 72 of the lower back portion 20. In certain embodiments, the waist strap is an adjustable cinching strap as is well known in the art. In some embodiments, the waist strap includes a cinching device as is well known in the art. In certain embodiments, the cinching device is configured for adjusting the length of the strap in a manner well known in the art. In some embodiments, the waist strap includes a buckle or cooperating fasteners, as is well known in the art. In some embodiments, the first and second ends 70 and 72 include lineman's strap loops 116 and 118. In some embodiments, the waist strap is a separate component having opposing first and second ends respectively coupled to the lineman's strap loops 116 and 118.

In a non-limiting exemplary embodiment, at least a portion of one or more of the tether 14, the left shoulder strap 24, the right shoulder strap 26, the chest strap 28, the left leg strap 30, the right leg strap 32, and the coupling between the upper and lower back portions 18 and 20 is elastic. In some embodiments, at least a portion of the one or more of the tether 14, the straps and the coupling between the back portions includes an elastic webbing as is well known in the art. In certain embodiments, at least a portion of the one or more of the tether, the straps and the coupling between the back portions has an elasticity greater than that of the prior art torso harness systems. In some embodiments, the elasticity is approximately 10% greater than that of the prior art torso harness systems. In certain embodiments, the stretch/elastic characteristic is more than 10% greater than that of the prior art torso harness systems. As will be apparent to one skilled in the art, while being configured to arrest the fall of the user and to absorb the energy of the fall, the structural integrity of the torso harness system must be maintained under all circumstances.

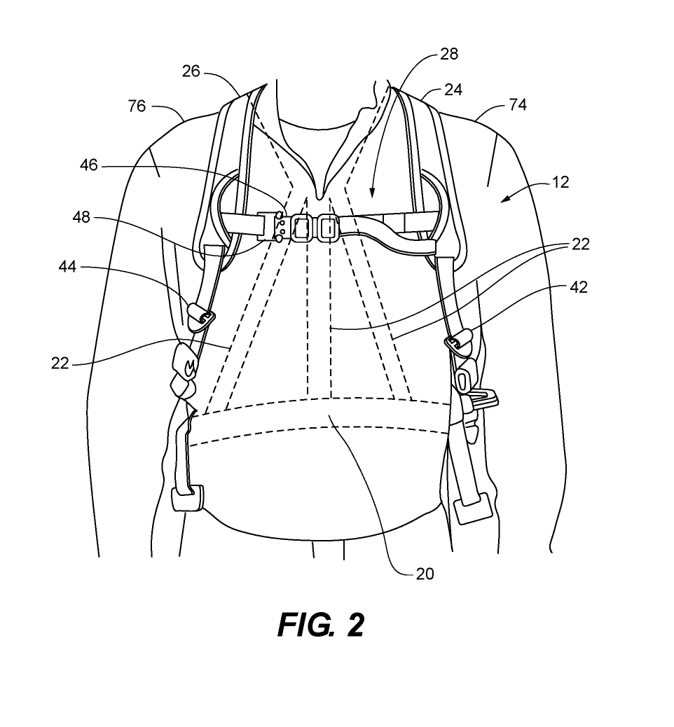

FIGS. 2-9 illustrate some of the steps associated with a non-limiting exemplary embodiment of a method of using the fall arrest system 10.

FIG. 2 illustrates the torso harness system 12 positioned or placed around the user's torso with the lower back portion 20 (shown in dashed lines) positioned against the user's lower back, and the left and right shoulder straps 24 and 26, respectively, positioned over the user's left and right shoulders. The chest strap 28 is secured across the user's chest or upper front torso and adjusted to ensure a snug fit. Functionally, the chest strap 28 is configured to limit the movement of the left and right shoulder straps 24 and 26 away from each other and inhibit the shoulder straps from falling off the user's left and right shoulders 74 and 76.

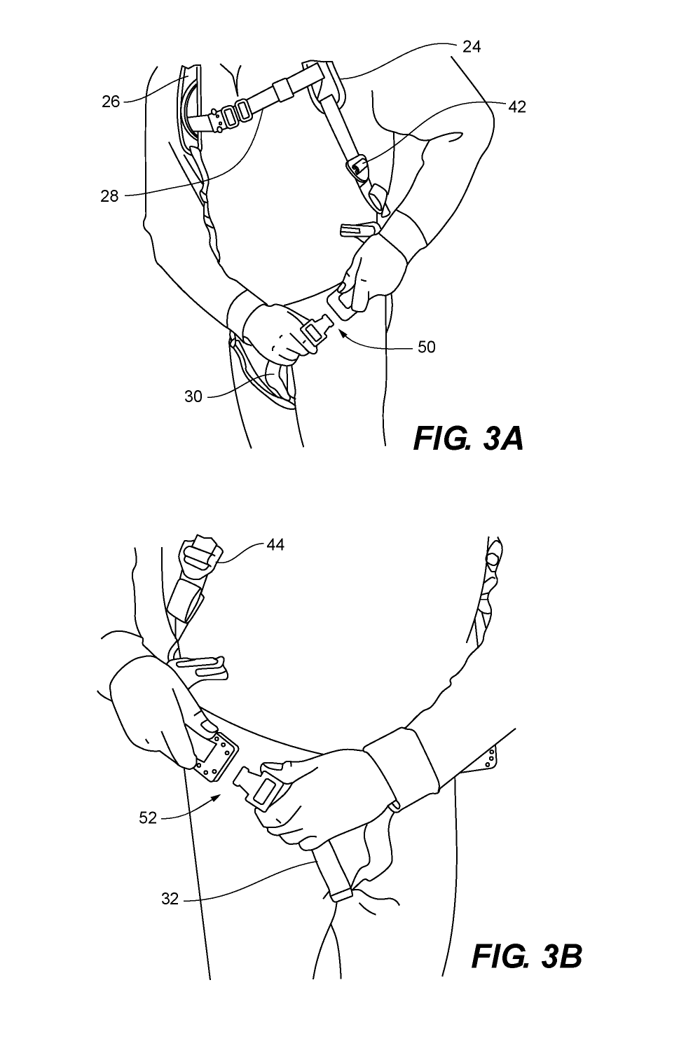

FIGS. 3A and 3B, respectively, illustrate the disposition of the left and right leg straps 30 and 32 about the user's left and right legs. In this embodiment, the leg straps 30 and 32 are illustrated as two-piece straps. The leg straps 30 and 32, respectively, include fasteners, e.g., buckles, 50 and 52 for securing the leg straps around the user's legs. The left and right leg straps 30 and 32 are adjusted to form a snug fit around the upper portion of the user's legs.

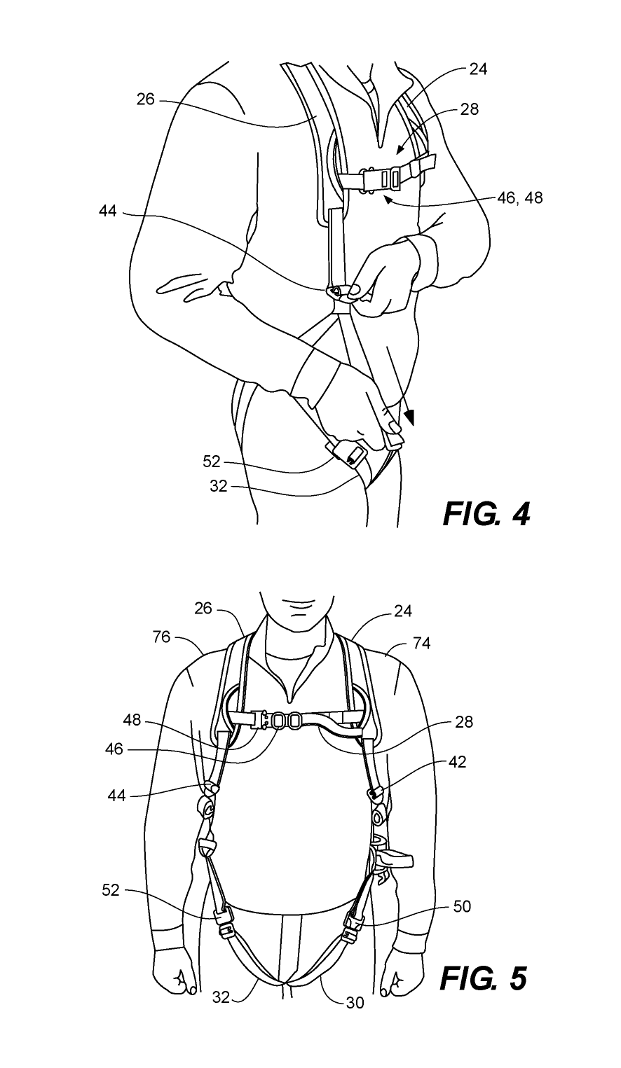

FIG. 4 illustrates the user adjusting the length of the right shoulder strap 26. Likewise, though not illustrated, the length of the left shoulder strap 24 is also adjusted.

The left and right shoulder straps 24 and 26, the chest strap 28, and the left and right leg straps 30 and 32 are adjusted by the user to ensure a snug fit of the torso harness system 12 around the torso as illustrated in FIG. 5.

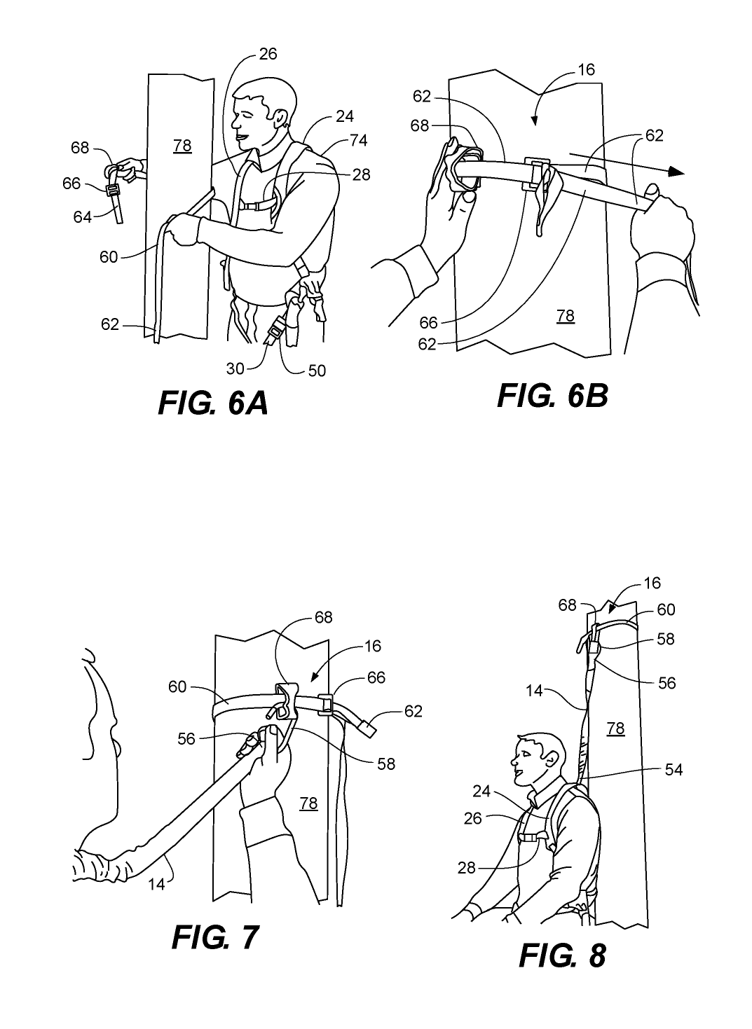

FIGS. 6A and 6B illustrate a non-limiting exemplary embodiment of a method of securing the securement system 16 to an object or an anchoring structure 78. In some embodiments, the object or the anchoring structure 78 to which the securement system 16 is secured to a pole or a tree trunk. However, this should not be construed as limiting with respect to the application or use of the securement system 16 and/or the structure 78 to which it is secured. In a non-limiting exemplary embodiment, the first end 62 of the strap 60 is wrapped around the structure 78, and is then coupled to the securement device 66 and cinched until the securement system 16 is snug secured to the structure 78.

Next, the tether 14 and the securement system 16 are detachably coupled to each other. FIG. 7 illustrates a non-limiting exemplary embodiment of detachably coupling the second end 56 of the tether 14 and the anchoring device or point 68 of the securement system 16 to each other. In some embodiments, the carabiner 58 is used for detachably coupling the second end 56 and the anchoring device or point 68. As illustrated in FIG. 8, in the case of an accidental fall, the fall distance experienced by the user of the fall arrest system 10 will be limited by the length of the tether 14.

As described elsewhere, at least a portion of one or more of the tether 14, the left shoulder strap 24, the right shoulder strap 26, the chest strap 28, the left leg strap 30, the right leg strap 32, and the coupling between the upper and lower back portions 18 and 20 is elastic. In a non-limiting exemplary embodiment, an elastic webbing construction provides the desired level or degree of elasticity without compromising the structural integrity of the fall arrest system 10. In some embodiments, the elastic webbing construction increases the user's flexibility especially while moving about at elevated heights. For instance, the increased flexibility provided by the elastic shoulder straps 24 and 26 may minimize accidental falls when the user stretches or moves at elevated heights, especially on small or narrow platforms, such as a hunting platform.

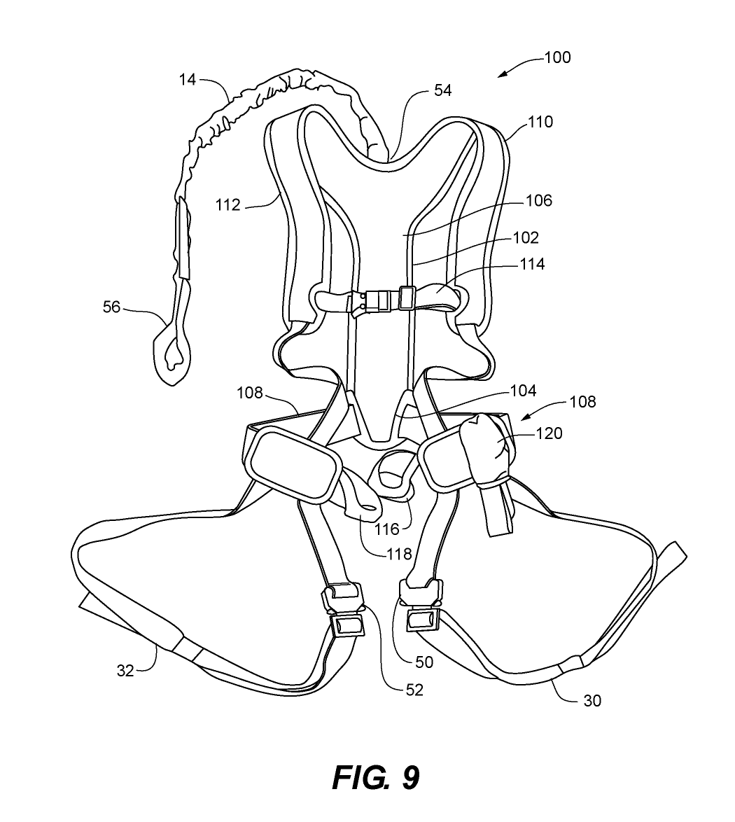

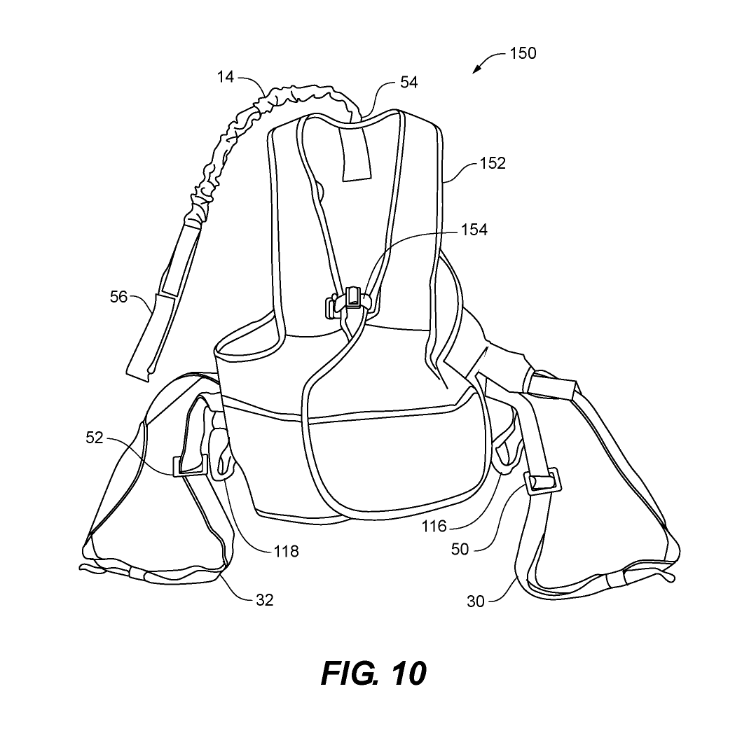

FIG. 9 illustrates a non-limiting exemplary embodiment of a torso harness system 100 used with the tether 14 and the securement system 16 (not shown) in a fall arrest system. As will be briefly described, several aspects of the torso harness system 100 are substantially similar to those of the torso harness system 12, and are therefore identified or indicated with like reference numerals. In some embodiments, the torso harness system 100 includes a back portion 102 extending between first and second ends 104 and 106, a waist portion 108 coupled to the first end 104 of the back portion 102, and adjustable left and right shoulder straps 110 and 112 coupled to and extending between the second end 106 of the back portion 102 and the waist portion 108. In some embodiments, the torso harness system 100 includes a sternum strap 114 extending across the front portion of the user's torso in the vicinity of the sternum. In certain embodiments, the torso harness system 100 includes a chest strap 28 either in the alternative or in addition to the sternum strap 114.

As with the left and right shoulder straps 24 and 26, the left and right shoulder straps 110 and 112 are also adjustable. In some embodiments, the left and right shoulder straps 110 and 112 are configured substantially similar to the left and right shoulder straps 24 and 26. Likewise, the sternum strap 114 is also adjustable in a manner substantially similar to the chest strap 28. In certain embodiments, at least a portion of one or more of the back portion 102, the left shoulder strap 110, the right shoulder strap 112, and the sternum strap 114 is elastic and/or is made or constructed from a webbing material having elastic characteristics.

In some embodiments, the waist portion 108 extends between first and second ends 116 and 118 which are coupleable to each other such that the waist portion 108 can be considered as a belt around the user's waist. In certain embodiments, the first and second ends are configured as a lineman's strap loops 116 and 118. In some embodiments, the torso harness system 100 includes a suspension relief device and/or a storage pouch 120 for stowing the securement system 16 when not in use.

FIG. 10 illustrates a non-limiting exemplary embodiment of yet another torso harness system 150 having a vest 152 configured for securement around a user's torso. In some embodiments, the vest 152 replaces the shoulder straps, waist portion, back portions, etc., that are included in the torso harness systems 12 and/or 100. In certain embodiments, the vest 152 is in addition to one or more of the shoulder straps, waist portion, back portions, etc., that are included in the torso harness systems 12 and/or 100. In some embodiments, the vest 152 includes a sternum strap 154 extending across the lapels of the vest 152 in proximity of the user's sternum. In certain embodiments, the vest 152 includes one or more securement devices, e.g., latches, (not shown) along all or portions of the overlapping parts of the vest's lapels for snugly securing the vest 152 around the user's torso. In some embodiments, at least a portion of the vest 152 is at least partially elastic or is constructed from a webbing material having elastic properties. In some embodiments, the left and right leg straps 30 and 32, and the lineman's strap loops 116 and 118 are coupled to the vest 152. In certain embodiments, the left and right leg straps 30 and 32 are coupled to the vest 152, and the lineman's strap loops 116 and 118 are coupled to the left and right leg straps 30 and 32. In some embodiments, the lineman's strap loops 116 and 118 are coupled to the vest 152, and the left and right leg straps 30 and 32 are coupled to the lineman's strap loops 116 and 118. In certain embodiments, the vest 152 includes an integral or separate lower back portion, e.g., lower back portion 20, to which the left and right leg straps 30 and 32 and/or the lineman's strap loops 116 and 118 are coupled. In some embodiments, the vest 152 includes an integral or separate waist belt or waist portion, e.g., waist portion 108, to which the left and right leg straps 30 and 32 and/or the lineman's strap loops 116 and 118 are coupled.

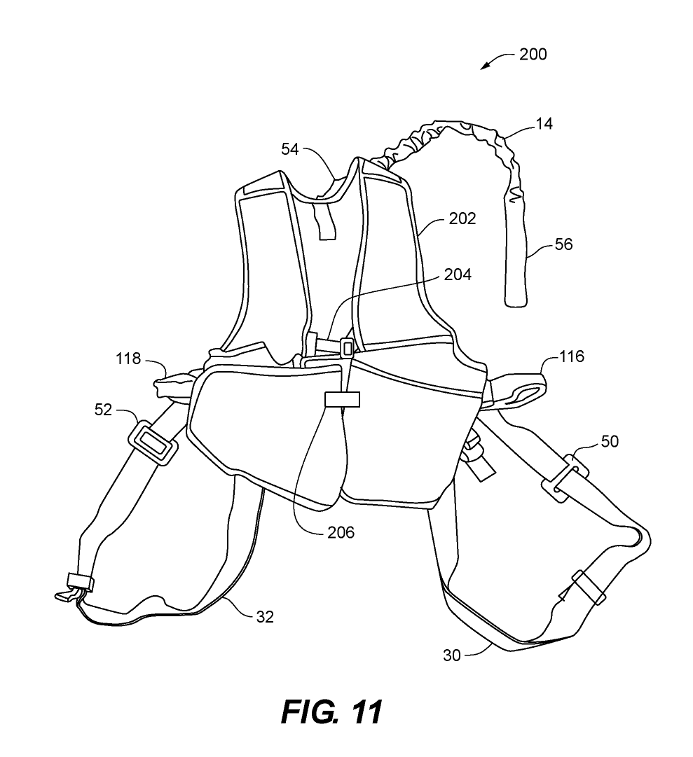

FIG. 11 illustrates a non-limiting exemplary embodiment of another torso harness system 200 having a vest 202 configured for securement around a user's torso. In some embodiments, the vest 202 replaces the shoulder straps, waist portion, back portions, etc., that are included in the torso harness systems 12 and/or 100. In certain embodiments, the vest 202 is in addition to one or more of the shoulder straps, waist portion, back portions, etc., that are included in the torso harness systems 12 and/or 100. In some embodiments, the vest 202 includes a sternum strap 204 extending across the lapels of the vest 202 in proximity of the user's sternum. In certain embodiments, the vest 202 includes one or more securement devices, e.g., latches, 206 along all or portions of the vest's lower lapels for snugly securing the vest 202 around the user's torso. In some embodiments, at least a portion of the vest 202 is at least partially elastic or is constructed from a webbing material having elastic properties. In some embodiments, the left and right leg straps 30 and 32, and the lineman's strap loops 116 and 118 are coupled to the vest 202. In certain embodiments, the left and right leg straps 30 and 32 are coupled to the vest 202, and the lineman's strap loops 116 and 118 are coupled to the left and right leg straps 30 and 32. In some embodiments, the lineman's strap loops 116 and 118 are coupled to the vest 202, and the left and right leg straps 30 and 32 are coupled to the lineman's strap loops 116 and 118. In certain embodiments, the vest 202 includes an integral or separate lower back portion, e.g., lower back portion 20, to which the left and right leg straps 30 and 32 and/or the lineman's strap loops 116 and 118 are coupled. In some embodiments, the vest 202 includes an integral or separate waist belt or waist portion, e.g., waist portion 108, to which the left and right leg straps 30 and 32 and/or the lineman's strap loops 116 and 118 are coupled.

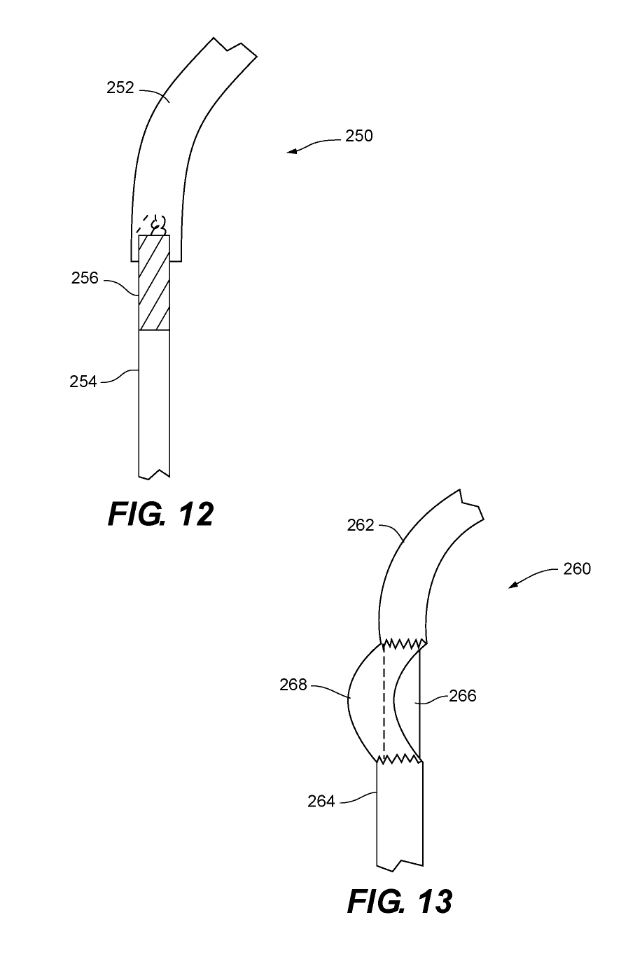

FIG. 12 illustrates a non-limiting exemplary embodiment of a shoulder strap 250 having section 252, 254, and 256. In some embodiments, the sections 252 and 254 are constructed from a relatively rigid conventional material, and the intervening section 256 is constructed from an at least partially elastic webbing material. As illustrated, the opposing ends of the intervening section 256 are respectively coupled to the sections 252 and 254. As will be apparent to one skilled in the art, the shoulder strap 250 is configured to stretch along the intervening section 256 which enhances the user's freedom of movement. Additionally, the shoulder strap 250 is configured to absorb at least a portion of the energy in the event of a fall. In some embodiments, the intervening section 256 is configured to stretch or elongate by about 10% in length. In certain embodiments, the intervening section 256 is configured to permit the shoulder strap 250 to stretch or elongate by about 10% in its overall length. However, this limitation on the elasticity of the shoulder strap 250 and/or the intervening section 256 is not limiting and should not be construed as such.

FIG. 13 illustrates another non-limiting exemplary embodiment of a shoulder strap 260 having section 262, 264, and 266 that are substantially similar to the sections 252, 254, and 256 of the shoulder strap 250. The shoulder strap 260 includes an expansion section 268 overlapping the intervening section 266 and coupled to the sections 262 and 264 at the same location whereat the intervening section 266 is coupled to the sections 262 and 264. In some embodiments, the expansion section 268 is constructed from the same relatively rigid conventional material from which the sections 262 and 264 are constructed, and is configured to provide some slack between the sections 262 and 264. As will be apparent to one skilled in the art, the expansion section 268 will limit the extent to which the intervening section 266, and consequently the shoulder strap 260, is permitted to stretch. In some embodiments, the sections 262, 264, and 266 of the shoulder strap 260 are formed as a single continuous piece of the relatively rigid conventional material, and the elastic intervening section 266 is coupled to a portion of the single continuous piece to provide a slack over the intervening section 266.

In view thereof, modified and/or alternate configurations of the embodiments described herein may become apparent or obvious to one of ordinary skill. All such variations are considered as being within the metes and bounds of the instant disclosure. For instance, while reference may have been made to particular feature(s) and/or function(s), the disclosure is considered to also include embodiments configured for functioning and/or providing functionalities similar to those disclosed herein with reference to the accompanying drawings. Accordingly, the spirit, scope and intent of the instant disclosure is to embrace all such variations. Consequently, the metes and bounds of the disclosure is solely defined by the appended claims and any and all equivalents thereof.

What is claimed is:

1. A fall arrest system, comprising:
a torso harness system, comprising:
an upper back portion;
a lower back portion coupled to the upper back portion;
left and right shoulder straps, each shoulder strap coupled to and extending between the upper back portion and the lower back portion;
a chest strap extending between the left and right shoulder straps; and
left and right leg straps, each leg strap defined at least in part by opposing first and second ends coupled to the lower back portion;
a tether defined at least in part by opposing first and second ends, wherein the first end of the tether is coupled to the torso harness system; and
a securement system configured for being secured to an object;
wherein, at least a portion of at least one of the left shoulder strap, the right shoulder strap, the tether, the coupling between the upper and lower back portions, the left leg strap, and the right leg strap is elastic; and
wherein during use, the second end of the tether and the securement system are detachably coupled to each other.

2. The fall arrest system of claim 1, wherein a length of one or more of the left and right shoulder straps, the chest strap, and the left and right leg straps is adjustable.

3. The fall arrest system of claim 1, wherein one or both of the left and right shoulder straps is a two-piece strap comprising a fastener for detachably coupling the two pieces of the strap to each other to form a continuous shoulder strap.

4. The fall arrest system of claim 3, wherein the fastener is configured for adjusting a length of the shoulder strap.

5. The fall arrest system of claim 1, wherein the chest strap is a two-piece strap comprising a fastener for detachably coupling the two pieces of the strap to each other to form a continuous chest strap.

6. The fall arrest system of claim 5, wherein the fastener is configured for adjusting a length of the chest strap.

7. The fall arrest system of claim 1, wherein one or both of the left and right leg straps is a two-piece strap comprising a fastener for detachably coupling the two pieces of the strap to each other to form a continuous leg strap.

8. The fall arrest system of claim 7, wherein the fastener is configured for adjusting a length of the leg strap.

9. The fall arrest system of claim 1, comprising a carabiner for detachably coupling the second end of the tether and the securement system to each other.

10. The fall arrest system of claim 1, wherein the first end of the tether is coupled to the upper back portion.

11. The fall arrest system of claim 1, wherein the securement system is configured for forming a loop having an adjustable diameter.

12. The fall arrest system of claim 1, wherein
the lower back portion comprises opposing first and second ends and extends across at least a portion of a user's back along the user's waist; and
the opposing first and second ends are configured for being coupled to each other across the user's front portion of the waist to form a loop about the user's waist.

13. The fall arrest system of claim 12, wherein a diameter of the loop about the user's waist is adjustable.

14. A fall arrest system, comprising:
a torso harness system, comprising:
a back portion extending between opposing first and second ends;
a waist portion coupled to the first end of the back portion;
left and right shoulder straps, each shoulder strap coupled to and extending between the second end of the back portion and the waist portion;
a chest strap extending between the left and right shoulder straps; and
left and right leg straps defined at least in part by opposing first and second ends coupled to the waist portion;
a tether defined at least in part by opposing first and second ends, wherein the first end of the tether is coupled to the torso harness system; and
a securement system configured for being secured to an object;
wherein, at least a portion of at least one of the back portion, the left shoulder strap, the right shoulder strap, the tether, the left leg strap, and the right leg strap is elastic; and
wherein during use, the second end of the tether and the securement system are detachably coupled to each other.

15. The fall arrest system of claim 14, wherein a length of one or more of the back portion, the waist portion, the left and right shoulder straps, the chest strap, the left and right leg straps is adjustable.

16. The fall arrest system of claim 14, wherein one or both of the left and right shoulder straps is a two-piece strap comprising a fastener for detachably coupling the two pieces of the strap to each other to form a continuous shoulder strap.

17. The fall arrest system of claim 14, wherein the chest strap is a two-piece strap comprising a fastener for detachably coupling the two pieces of the strap to each other to form a continuous chest strap.

18. The fall arrest system of claim 14, wherein one or both of the left and right leg straps is a two-piece strap comprising a fastener for detachably coupling the two pieces of the strap to each other to form a continuous leg strap.

19. The fall arrest system of claim 14, wherein the securement system is configured for forming a loop having an adjustable diameter.

20. The fall arrest system of claim 14, wherein the waist portion is configurable as an adjustable belt extending around a user's waist.
